(19) United States
(12) Patent Application Publication
(10) Pub. No.: US 2009/0006902 A1
(43) Pub. Date: Jan. 1, 2009

(54) METHODS, SYSTEMS, AND COMPUTER PROGRAM PRODUCTS FOR REPORTING FRU FAILURES IN STORAGE DEVICE ENCLOSURES

(75) Inventors: Philip M. Corcoran, Highland, NY (US); William P. Kostenko, Poughkeepsie, NY (US); William J. Petrowsky, Kingston, NY (US); Edward J. Seminaro, Milton, NY (US)

Correspondence Address: CANTOR COLBURN LLP-IBM POUGHKEEPSIE, 20 Church Street, 22nd Floor, Hartford, CT, 06103, US

(73) Assignee: INTERNATIONAL BUSINESS MACHINES CORPORATION, ARMONK, NY (US)

(21) Appl. No.: 11/771,148

(22) Filed: Jun. 29, 2007

(51) Int. Cl. G06F 11/30

(52) U.S. Cl. 714/48; 714/E11.024

(57) ABSTRACT

Monitoring a plurality of field-replaceable units (FRUs) in an enclosure using two or more microcontroller-equipped power supplies to detect an FRU failure. Upon detection of an FRU failure, a first signal indicative of the failure is communicated from at least one of the microcontroller-equipped power supplies to one or more small computer system interface (SCSI) repeaters over an I²C bus. The one or more SCSI repeaters report a second signal indicative of the failure to one or more central electronics complexes (CECs) over one or more SCSI busses. The first signal may, but need not, be substantially identical to the second signal.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to the field of computer systems management and, in particular, to methods, systems, and computer program products for reporting field-replaceable unit (FRU) failures in storage device enclosures.

2. Description of Background

A typical computer system may contain a plurality of direct access storage devices (DASDs) such as magnetic disk storage drives. A DASD drawer includes a plurality of DASDs mounted in an enclosure that provides electrical power, cooling, and protection from mechanical shock. The DASDs are connected to multiple central electronics complexes (CECs) through one or more small computer system interface (SCSI) busses. A SCSI bus is able to support up to fifteen devices, such as disk drives, CD-ROM drives, optical drives, printers, and communication devices. One of the advantages of the SCSI bus is its ability to easily adapt to new types of devices by using a standard set of commands such as the SCSI-3 command set.

From time to time, a field replaceable unit (FRU) in a DASD drawer, such as a DASD, power supply, cooling fan, or environmental control system, may fail or operate at a substandard level. In the case of a failed DASD, a computer operating system may detect and provide an indication of this failure to alert service personnel. This indication may be reported in the form of an error message such as “error reading drive X” (where X is the logical drive name). Failure of power supplies, cooling fans, and environmental control systems are reported over a separate system power control network (or service interface). More specifically, a computer system comprised of multiple enclosures provides interconnections among these enclosures using at least one system bus, such as a SCSI bus, along with separate service interface interconnections. Accordingly, in computer systems which employ a service interface to report FRU failures, it has been necessary to maintain two interfaces—namely, a system bus interface, as well as a separate, dedicated, out-of-band service interface.

The service interface is a low-volume serial network used to monitor power and cooling conditions for the enclosures of a computer system. The nodes in the service network typically include a microprocessor and related circuitry which monitors the status of, and makes occasional adjustments to, the power and/or cooling conditions at the enclosure. These and related functions are sometimes referred to as “enclosure services”. However, the need for a separate service interface in addition to the system bus interface adds to the complexity and overall cost of maintaining the computer system. Additional cables and interconnections are required, as well as additional electronic circuitry which consumes energy and generates heat. Accordingly, it would be desirable to develop a failure reporting system for a DASD drawer or other type of enclosure that does not require use of a separate, out-of-band or service interface.

### SUMMARY OF THE INVENTION

The shortcomings of the prior art are overcome and additional advantages are provided by monitoring a plurality of field-replaceable units (FRUs) in an enclosure using two or more microcontroller-equipped power supplies to detect an FRU failure. Upon detection of an FRU failure, a first signal indicative of the failure is communicated from at least one of the microcontroller-equipped power supplies to one or more small computer system interface (SCSI) repeaters over an I²C bus. The one or more SCSI repeaters report a second signal indicative of the failure to one or more central electronics complexes (CECs) over one or more SCSI busses. The first signal may, but need not, be substantially identical to the second signal.

### TECHNICAL EFFECTS

As a result of the summarized invention, technically we have achieved a solution wherein FRU failures in an enclosure such as a DASD drawer are detected by a microcontroller-equipped power supply and reported by a SCSI repeater to one or more CECs over a SCSI bus, thereby eliminating the need for a separate, out-of-band failure reporting interface such as a service interface.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram of an exemplary system that may be utilized to report field replaceable unit (FRU) failures in a storage device enclosure; and

FIG. 2 is a flow diagram of an exemplary process for reporting FRU failures in a storage device enclosure.

### DETAILED DESCRIPTION OF THE INVENTION

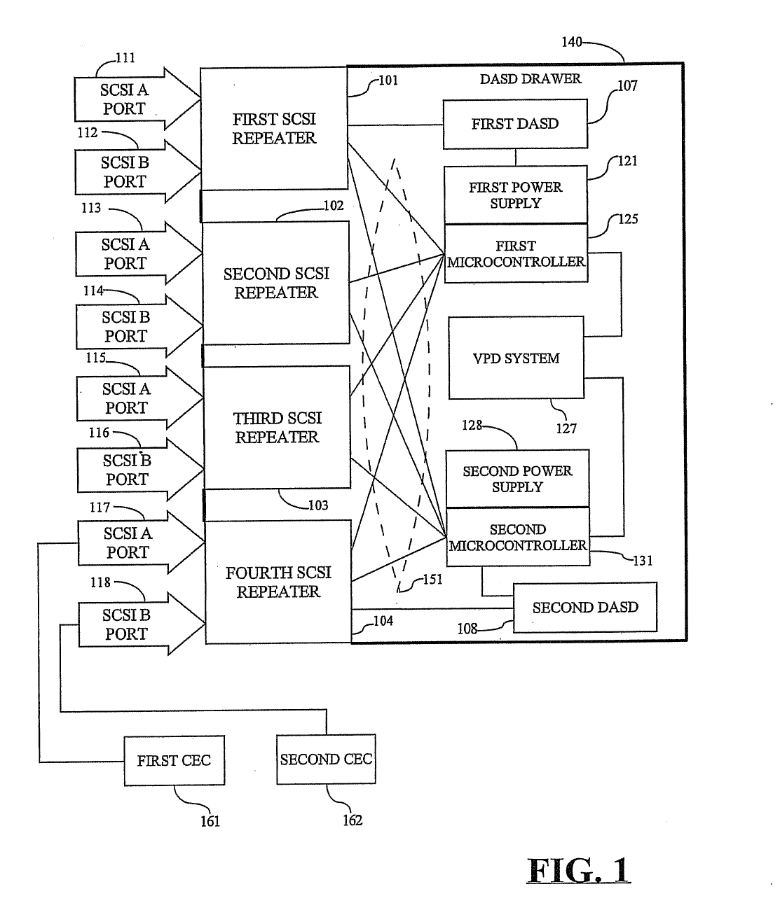

FIG. 1 is a block diagram of an exemplary system that may be utilized to report field replaceable unit (FRU) failures in a storage device enclosure. The storage device enclosure is illustratively implemented in the form of a direct access storage device (DASD) drawer 140. A plurality of DASDs, such as first DASD 107 and second DASD 108, are mounted in DASD drawer 140. First and second DASDs 107, 108 each represent, for example, magnetic disk storage drives. DASD drawer 140 provides DASDs 107, 108 with electrical power, cooling, and protection from mechanical shock.

DASDs 107, 108 are connected to multiple central electronics complexes (CECs), such as a first CEC 161 and a second CEC 162, through one or more small computer system interface (SCSI) busses. A SCSI bus is able to support up to fifteen devices, such as disk drives, CD-ROM drives, optical drives, printers, and communication devices. In the illustrative example of FIG. 1, four separate SCSI busses are implemented using a first SCSI repeater 101, a second SCSI repeater 102, a third SCSI repeater 103, and a fourth SCSI repeater 104, although any number of SCSI busses and SCSI repeaters could be present.

SCSI repeaters 101, 102, 103, and 104 are each active repeater devices that do not require a SCSI bus ID. First SCSI repeater 101 includes two ports in the form of a SCSI A port 111 and a SCSI B port 112. Similarly, second SCSI repeater 102 includes two ports in the form of a SCSI A port 113 and a SCSI B port 114. Likewise, third SCSI repeater 103 includes two ports in the form of a SCSI A port 115 and a SCSI B port 116. Finally, fourth SCSI repeater 104 includes two ports in the form of a SCSI A port 117 and a SCSI B port 118. Each SCSI A port-SCSI B port pair, such as SCSI A port 111 and SCSI B port 112, includes active bus termination and logic to regenerate SCSI bus signals through the corresponding SCSI repeater, such as first SCSI repeater 101. Port A 111, 113, 115, 117 and Port B 112, 114, 116, 118 can each be operably connected to a full length SCSI bus, thereby doubling the total operable SCSI bus length possible for a given system. For example, in the absence of first, second, third, and fourth SCSI repeaters 101, 102, 103, 104, the maximum standard SCSI bus length for SCSI Ultra 320 is 24 meters.

A first microcontroller equipped power supply including a first power supply 121 and a first microcontroller 125 supplies all DASDs 107 and 108 with electrical power. Similarly, a second microcontroller equipped power supply including a second power supply 128 and a second microcontroller 131 can be added for redundancy. Therefore, first and second microcontroller equipped power supplies are redundant supplies for DASD drawer 140, such that the first microcontroller equipped power supply supplies electrical power to both first and second DASDs 107, 108 in the event of failure of second power supply 128 in an N+1 fashion. Likewise, the second microcontroller equipped power supply supplies electrical power to both first and second DASDs 107, 108 in the event of failure of first power supply 121.

First and second microcontrollers 125, 131 are capable of communicating with a vital product data (VPD) system 127. VPD is information about a device, such as first DASD 107 or second DASD 108, that is stored on a hard drive in VPD system 127 (or the device itself, or both) that allows the device to be administered at a system or network level. Typical VPD information includes a product model number, a unique serial number, product release level, maintenance level, and other information specific to the device type. VPD could, but need not, also include user-defined information, such as the building and department location of the device. The collection and use of VPD allows the status of a network or computer system to be understood by service technicians so that service may be provided more expeditiously.

From time to time, a field replaceable unit (FRU) in a DASD drawer, such as first DASD 107, second DASD 108, first power supply 121, second power supply 128, a cooling fan, or an environmental control system, may fail or operate at a substandard level. Accordingly, two or more microcontroller equipped power supplies such as first power supply 121-first microcontroller 125 and second power supply 128-second microcontroller 131, are used to monitor a plurality of field-replaceable units (FRUs) in DASD drawer 140 to detect an FRU failure. Upon detection of an FRU failure, a first signal indicative of the failure is communicated from at least one of the microcontroller-equipped power supplies to one or more small computer system interface (SCSI) repeaters, such as first, second, third, and fourth SCSI repeaters 101, 102, 103, 104 over an Inter-Integrated-Circuit (I²C) bus 151. The I²C bus is a bi-directional two-wire serial bus that provides a communication link between two or more integrated circuits (ICs).

In response to receipt of the first signal, the one or more SCSI repeaters 101, 102, 103,104 report a second signal indicative of the failure to one or more central electronics complexes (CECs) 161, 162 over one or more (SCSI) busses. The first signal may, but need not, be substantially identical to the second signal. In this manner, FRU failures in DASD drawer 140 are detected by first microcontroller 125 or second microcontroller 131, and then reported by a SCSI repeater 101, 102, 103, and/or 104, to one or more CECs 161, 162 over a SCSI bus, thereby eliminating the need for a separate, out-of-band failure reporting interface such as a service interface.

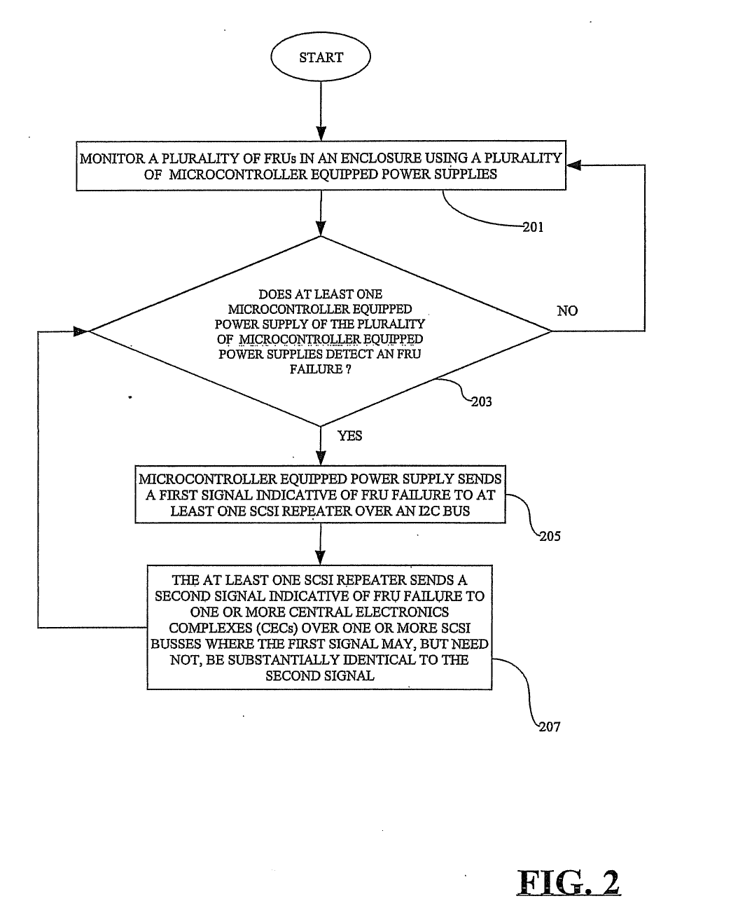

FIG. 2 is a flow diagram of an exemplary process for reporting field replaceable unit (FRU) failures in a storage device enclosure. The procedure commences at block 201 where a plurality of field-replaceable units (FRUs) in an enclosure are monitored using a plurality of microcontroller equipped power supplies to detect an FRU failure. Illustratively, the plurality of microcontroller equipped power supplies includes a first microcontroller equipped power supply comprising a first power supply 121 (FIG. 1) and a first microcontroller 125, as well as a second microcontroller equipped power supply comprising a second power supply 128 and a second microcontroller 131. At block 203 (FIG. 2), a test is performed to ascertain whether or not at least one microcontroller equipped power supply has detected an FRU failure. If not, the procedure loops back to block 201.

The affirmative branch from block 203 leads to block 205 where the at least one microcontroller equipped power supply sends a first signal indicative of the failure to one or more small computer system interface (SCSI) repeaters 101, 102, 103, 104 (FIG. 1) over I²C bus 151 (FIG. 1). Next, at block 207 (FIG. 2), the one or more SCSI repeaters 101, 102, 103, 104 report a second signal indicative of the failure to one or more central electronics complexes (CECs) 161, 162 (FIG. 1) over one or more SCSI busses. The first signal may, but need not, be substantially identical to the second signal. The procedure then loops back to block 201 (FIG. 2).

The foregoing exemplary embodiments may be provided in the form of computer-implemented processes and apparatuses for practicing those processes. The exemplary embodiments can also be provided in the form of computer program code containing instructions embodied in tangible media, such as floppy diskettes, CD ROMs, hard drives, or any other computer-readable storage medium, wherein, when the computer program code is loaded into and executed by a computer (such as, for example, at least one of first microcontroller 125 or second microcontroller 131 of FIG. 1), the computer becomes an apparatus for practicing the exemplary embodiments. The exemplary embodiments can also be provided in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the exemplary embodiments. When implemented on a general-purpose microprocessor, the computer program code segments execute specific microprocessor machine instructions. The computer program code could be implemented using electronic logic circuits or a microchip.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced items.

What is claimed is:

1. A method for reporting failure of a field replaceable unit (FRU) in a storage device enclosure, the method comprising:
monitoring a plurality of field-replaceable units (FRUs) in a storage device enclosure using two or more microcontroller-equipped power supplies to detect an FRU failure;
upon detection of an FRU failure, sending a first signal indicative of the failure from at least one of the two or more microcontroller-equipped power supplies to one or more small computer system interface (SCSI) repeaters over an I²C bus;
sending a second signal indicative of the failure from the one or more SCSI repeaters to one or more central electronics complexes (CECs) over one or more SCSI busses.

2. The method of claim 1 wherein the first signal is substantially identical to the second signal.

3. The method of claim 1 wherein the first signal is not substantially identical to the second signal.

4. The method of claim 1 wherein the FRU comprises a direct access storage device (DASD).

5. The method of claim 1 wherein the FRU comprises a power supply.

6. The method of claim 1 wherein the FRU comprises a cooling fan.

7. The method of claim 1 wherein the FRU comprises an environmental control system.

8. A computer program product comprising a storage medium readable by a processing circuit and storing instructions for execution by the processing circuit for facilitating a method for reporting failure of a field replaceable unit (FRU), the method comprising:
monitoring a plurality of field-replaceable units (FRUs) in a storage device enclosure using two or more microcontroller-equipped power supplies to detect an FRU failure;
upon detection of an FRU failure, sending a first signal indicative of the failure from at least one of the two or more microcontroller-equipped power supplies to one or more small computer system interface (SCSI) repeaters over an I²C bus;
sending a second signal indicative of the failure from the one or more SCSI repeaters to one or more central electronics complexes (CECs) over one or more SCSI busses.

9. The computer program product of claim 8 wherein the first signal is substantially identical to the second signal.

10. The computer program product of claim 8 wherein the first signal is not substantially identical to the second signal.

11. The computer program product of claim 8 wherein the FRU comprises a direct access storage device (DASD).

12. The computer program product of claim 8 wherein the FRU comprises a power supply.

13. The computer program product of claim 8 wherein the FRU comprises a cooling fan.

14. The computer program product of claim 8 wherein the FRU comprises an environmental control system.

15. A system for reporting failure of a field replaceable unit (FRU) in a storage device enclosure, the system comprising:
an Inter-Integrated-Circuit (I²C) bus;
one or more small computer system interface (SCSI) repeaters operably coupled to the I²C bus and to one or more SCSI busses; and
two or more microcontroller equipped power supplies operably coupled to the I²C bus, each microcontroller equipped power supply capable of monitoring a plurality of FRUs in a storage device enclosure to detect an FRU failure and, upon detection thereof, generating a first signal indicative of the failure and sending the first signal to the one or more SCSI repeaters over the I²C bus;
wherein the one or more SCSI repeaters sends a second signal indicative of the failure to one or more central electronics complexes (CECs) over the one or more SCSI busses.

16. The system of claim 15 wherein the first signal is substantially identical to the second signal.

17. The system of claim 15 wherein the first signal is not substantially identical to the second signal.

18. The system of claim 15 wherein the FRU comprises a direct access storage device (DASD).

19. The system of claim 15 wherein the FRU comprises a power supply.

20. The system of claim 15 wherein the FRU comprises at least one of a cooling fan or an environmental control system.
